(19) United States
(12) Patent Application Publication
(10) Pub. No.: US 2025/0108781 A1
(43) Pub. Date: Apr. 3, 2025

(54) FUNCTIONAL SYSTEM ARRANGEMENT WITH A COMPONENT-PUSH-ROD UNIT

(71) Applicant: Robert Bosch GmbH, Stuttgart (DE)

(72) Inventors: Andreas Weh, Sulzberg (DE); Joji Naka, Immenstadt (DE)

(21) Appl. No.: 18/811,884

(22) Filed: Aug. 22, 2024

(30) Foreign Application Priority Data
Sep. 29, 2023 (DE) 10 2023 209 574.2

(51) Int. Cl. B60T 7/06; G05G 1/46

(52) U.S. Cl. CPC B60T 7/06; G05G 1/46

(57) ABSTRACT

A functional system arrangement for a vehicle brake system in an associated vehicle on a vehicle wall. The functional system includes a component of a functional system of the vehicle brake system to be fastened to the vehicle wall, and a push rod coupled to the component. The component has a length extending along an X-axis and a height extending along a Z-axis perpendicular to the X-axis, and a component-push-rod unit is formed with the component and the push rod, the component-push-rod unit running with its longitudinal extension along the X-axis, the component-push-rod unit is to be arranged on the vehicle wall rotated by an angle about the Z-axis.

### CROSS REFERENCE

The present application claims the benefit under 35 U.S.C. § 119 of German Patent Application No. DE 10 2023 209 574.2 filed on Sep. 29, 2023, which is expressly incorporated herein by reference in its entirety.

### FIELD

The present invention relates to a functional system arrangement for a vehicle brake system in an associated vehicle on a vehicle wall provided there, including a component of a functional system of the vehicle brake system to be fastened to the vehicle wall, and a push rod coupled to the component, wherein the component has a length extending along an X-axis, and a component-push-rod unit is formed with the component and the push rod, the longitudinal extension of said unit running along the X-axis.

### BACKGROUND INFORMATION

Conventional component-push-rod units belong to vehicle brake systems in vehicles or motor vehicles. There, such units are attached to a vehicle wall that separates an engine compartment from a driver's compartment. The component is located in the engine compartment and the push rod protrudes into the driver's compartment through an opening in the vehicle wall or bulkhead. There, the push rod, as the input rod of a pedal travel sensor, is coupled to a pedal that can be actuated by the driver. When the pedal is actuated, the push rod is deflected via a partial circular movement of the pedal. The force generated by the driver is transmitted via the push rod to a hydraulic pressure device coupled thereto, which device is usually designed as a master brake cylinder and arranged in the component.

Such hydraulic pressure devices are part of one or more functional systems that provide controlled braking pressures to associated brake systems. The functional system used to regulate the brake pressure is usually a hydraulic unit comprising a hydraulic housing or housing as a component that is attached to the vehicle wall. The housing contains various hydraulic components, such as valves, sensors, accumulators, damper chambers, and pressure devices. Another functional system is a brake booster arranged between the hydraulic unit and the vehicle and coupled to the pedal travel sensor, with a booster housing as a component attached to the bulkhead.

Such functional systems represent actuation and modulation systems for brake pressure and are arranged with their associated housings as components in the engine compartment. Starting from the vehicle wall, the housing protrudes as a component with its length or longitudinal extension in the X direction into a region facing away from the driver's compartment. There are various components there, such as a battery, or other components, such as body parts, which can lead to conflicts. This can lead to overlaps. Furthermore, there may be insufficient free space, either overall or to meet certain crash requirements.

### SUMMARY

According to an example embodiment of the present invention, a functional system arrangement for a vehicle brake system in an associated vehicle is created on a vehicle wall provided there, comprising a component of a functional system of the vehicle brake system to be fastened to the vehicle wall, and a push rod coupled to the component, wherein the component has a length or longitudinal extension extending along an X-axis, a height or height extension extending along a Z-axis perpendicular to the X-axis, and in particular a width extension or width extending along a Y-axis perpendicular to the Z-axis, and with the component and the push rod a component-push-rod unit is formed, the longitudinal extension of which runs along the X-axis. The component-push-rod unit is to be arranged on the vehicle wall at an angle, or angle of rotation about the Z-axis, or arranged on the vehicle wall in the assembled state. In particular, the Y-axis or the width of the component and the vehicle wall enclose the mentioned angle in, in each case, a fictive surface extension. A rotation about the Z-axis is provided, in particular, as needed, clockwise or counterclockwise by the specified angle. Furthermore, the Z-axis of a fictive right-handed Cartesian coordinate system defines a Z-direction which, in the installed position in the vehicle, points substantially upwards, even diagonally upwards. The Z-axis extends in particular between a container side of the component and its opposite side and points in the direction towards the container side. A container for storing brake fluid is to be arranged on the container side.

An arrangement rotated in accordance with the present invention in this way is considered starting from an otherwise at least substantially vertical position of the push rod in its longitudinal extension to the vehicle wall. In such a position, the Y-axis and a plane formed with the vehicle wall enclose no or almost no angle; i.e., there is an angle there of approximately 0°. This means that the component of conventional component-push-rod units extends into the engine compartment with its length in the X direction substantially perpendicular to the vehicle wall. At the same time, an associated hydraulic system, in particular a required master brake cylinder, is aligned linearly to a direction of movement of an associated pedal.

In contrast, according to the present invention, the push rod is not arranged perpendicular to the vehicle wall or to a plane formed with the vehicle wall. Rather, the push rod and thus the component coupled to the push rod are arranged rotated about the Z-axis, in such a way that the aforementioned angle is to be enclosed, or is enclosed, between the Y-axis or the width of the component and the vehicle wall. At the same time, in particular the push rod and a master brake cylinder preferably arranged in the component are arranged linearly, or axially, to one another.

With such a rotated arrangement, possible component conflicts in the engine compartment, especially in the region facing away from the driver's compartment, are avoided. In addition, more space is created for a needs-based design and positioning of the components to be arranged there. Finally, depending on the type of vehicle, there are different engine compartments of different sizes in which different additional functional systems and/or additional components are to be accommodated. This means that the functional system can always be made to fit properly in the engine compartment.

The functional system arrangement according to the present invention is suitable for all functional systems or brake systems that are to be mounted on the bulkhead of the vehicle. Preferably, the functional system is a hydraulic unit and the associated component is a hydraulic housing, or a housing by which the hydraulic unit is to be attached to the bulkhead. Such a housing preferably belongs to a vacuum-independent, electrohydraulic functional system that includes brake booster and ESP functionality, such as an integrated power brake (IBP) or decoupled power brake (DPB) brake system. Furthermore, the functional system is preferably a brake booster and the component is a booster housing by which the brake booster is attached to the bulkhead. Particularly preferably, the functional system is a vacuum-independent, in particular electromechanical brake booster, such as a so-called iBooster.

According to an example embodiment of the present invention, advantageously, the angle is in a range between 1° and 30°, preferably from 2° to 20°, and particularly preferably from 3° to 10°. In particular, the amount of the angle is less than 10°, and is quite particularly preferably between 3.5° and 7°. Depending on requirements, the angle is positive or negative, i.e., runs clockwise or counterclockwise. With such an angle, the functional system can be flexibly attached to the vehicle wall and precisely fitted to the particular installation situation in the engine compartment. In particular, with the particularly preferred angle of 3° to 10°, a flexible inclination around the Z-axis of the component and thus of the associated functional system is achieved while at the same time achieving a savings of space needed for an angular segment required for this. In addition, the push rod is guided in a sufficiently stable, substantially linear manner, particularly relative to the master brake cylinder. Another advantage is that the angle is designed to be changeable or adjustable. Depending on the installation situation in the engine compartment, a suitable angle between the Y-axis or width of the component and the vehicle wall can be set only during assembly. This allows for particularly flexible installation of the functional system.

According to an example embodiment of the present invention, at least one fastening element to be coupled to the component is advantageously provided, the receiving point of which is arranged eccentrically, corresponding to the angle, in relation to the X-axis or to the longitudinal extension of the component-push-rod unit. The receiving point is preferably arranged directly on the component and particularly preferably on an interface device which is to be fastened to the component and serves to fasten the component to the vehicle wall. Preferably, at least two fastening elements are provided that are to be coupled to the component, the receiving points of which are arranged eccentrically to the X-axis. This means that at least two receiving points each have a different distance from the X-axis. In particular, the individual receiving point is shifted by a distance linearly in the opposite direction parallel to the Y-axis and is thus arranged eccentrically to the X-axis, which distance results from the angle at which the component-push-rod unit is rotated about the Z-axis. The starting point here is an arrangement of the individual receiving point with the component-push-rod unit not rotated about the Z-axis. In comparison, the position of each receiving point is advantageously shifted linearly along the Y-axis according to the present invention, so that a receiving opening or receptacle arranged in the vehicle wall through which the individual fastening element is to be guided can remain unchanged in the same position as such an opening when the push rod is arranged perpendicular to the vehicle wall. For this purpose, a receptacle is advantageously provided in the vehicle wall for receiving the individual fastening element and thus for fastening the component-push-rod unit, which receptacle is arranged at the same position as in a non-rotated arrangement. This means that the vehicle wall remains unchanged and no changes are required in the manufacturing process, saving costs. Furthermore, one type of vehicle wall can be used for multiple types of vehicles, so that higher quantities can be realized.

According to an example embodiment of the present invention, at least one receptacle arranged on the vehicle wall is advantageously provided for receiving the associated fastening element to be coupled to the component, which receptacle is arranged eccentrically in relation to the X-axis, corresponding to the angle. Preferably, at least two such receptacles are provided. Each receptacle is shifted linearly in opposite directions parallel to the Y-axis corresponding to the angle, compared to the non-rotated initial situation. This means that the individual fastening element can remain unchanged in its receiving point.

Furthermore, according to an example embodiment of the present invention, it is advantageous that the at least one fastening element to be coupled to the component and the at least one receptacle arranged on the vehicle wall are each arranged so as to be linearly displaced relative to one another or against one another in comparison to the non-rotated initial position in such a way that, when the component-push-rod unit is mounted on the vehicle in the rest position, a line of the longitudinal extensions of the push rod and of the piston of the master brake cylinder coupled thereto is produced.

In addition, the arrangement of the component-push-rod unit rotated about the Z-axis according to the present invention is advantageously created by means of a pivot point which is arranged compactly on the push rod. In particular, the pivot point is positioned axially away from the component, and is thus an external pivot point, or is arranged on the outside in relation to the component. This means that, when mounted, the pivot point is in the driver's compartment, where the pedal can engage the pivot point. Preferably, the pivot point is positioned at an axial end of the push rod opposite the component so that unhindered rotation is possible. For this purpose, the pivot point or rotation point is preferably and stably a ball head, which is particularly preferably made in one piece with the push rod.

According to an example embodiment of the present invention, in addition to the mentioned pivot point, a further pivot point is advantageously provided as an inner pivot point. The inner pivot point is arranged in particular at the axial end of the push rod which projects into the component, where it projects into a preferably arranged master brake cylinder and acts as a joint in a piston held therein. This provides a certain degree of flexibility, which can compensate for any stresses that may occur during operation.

Furthermore, the individual fastening element or its receiving point is displaced in particular linearly by a distance which results from a ratio of a direct distance between the outer pivot point and the inner pivot point to said angle.

According to an example embodiment of the present invention, the pivot point positioned axially away from the component is advantageously coupled in a rotatable or pivotable manner to a receiving position of an associated pedal device. In particular, the push rod is an input rod of an associated pedal travel sensor. Furthermore, the receiving position is preferably a receiving clamp or a clip, which is preferably designed in the shape of a half-shell and partially surrounds the pivot point on its peripheral surface. Such a clip is a well-known component in a pedal system. This means that known structures are used, which saves costs. For this purpose, the clip is preferably arranged on a curved pedal rod radially on the outside with its open side in such a way that the pivot point is partially received there. The pedal rod preferably has a pedal at one end and is movably suspended at its other end from a pedal bracket or a wall element of the vehicle.

In addition, according to an example embodiment of the present invention, when the component-push-rod unit is arranged rotated about the Z-axis, the pedal device is advantageously not arranged rotated in relation to the Z-axis. This means that the pedal device, in particular its pedal holder, pedal rod and pedal, is unchanged compared to a non-rotated arrangement. The pedal rod extends substantially perpendicular to a plane formed by the vehicle wall and the pedal remains unchanged in its pedal position. The pedal position is an essential architectural feature of vehicles. Shifting or changing its position is often not feasible or desired. Especially with existing vehicle models that are only being cosmetically changed, a change here is not possible, or is only possible to a limited extent. With the unchanged pedal position, existing structures in the driver's compartment are used effectively. At the same time, the rotated arrangement of the component-push-rod unit allows for substantially more freedom in the vehicle design in the engine compartment. Alternatively, the pedal device with its pedal rod is rotated about the Z-axis corresponding to the rotation of the component-push-rod unit. This results in a very low-wear arrangement of the pedal rod and push rod in a line, which means that there is no offset of the outer pivot point in the Y direction when the pedal is actuated.

Furthermore, according to an example embodiment of the present invention it is advantageous to additionally arrange the component-push-rod unit on the vehicle wall at an angle or angle of rotation about the Y-axis. This creates even more installation space options in the vehicle. In particular, installation space conflicts for a brake fluid container to be arranged in the Z direction can be avoided. For such a rotation about the Y-axis, a rotation angle of +5° to −44°, including a tolerance of in particular +/−5°, is advantageous, preferably of nominally 0° to −30° and particularly preferably nominally-8° to −25°.

In addition, according to an example embodiment the present invention, an interface device is advantageously provided which is used to fasten the push rod to the component and to fasten the component to the vehicle wall. The interface device is designed with a first contact surface that is directly or indirectly placed on the component or coupled to the component and with a second contact surface that is to be placed on the vehicle wall. The second contact surface is positioned at an angle to the first contact surface in such a way that the arrangement of the component-push-rod unit rotated at said angle about the Z-axis is achieved. The interface device is designed in particular such that the first contact surface is to be placed on the component in a first plane and the second contact surface facing the vehicle wall is to be placed on the vehicle wall in a second plane angled relative thereto. Preferably, the second contact surface is inclined with respect to the first contact surface in such a way that at the same time the arrangement of the component-push-rod unit advantageously additionally rotated about the Y-axis is achieved. The interface device designed with such an angle is to be placed on the component-push-rod unit as a separate component. This means that the component of the functional system, such as the hydraulic housing or booster housing, can be designed particularly cost-effectively without changing the vertical arrangement on the vehicle wall. At the same time, the rotated arrangement according to the present invention is achieved solely by means of the angled interface device, thus saving significant manufacturing costs. Accordingly, the present invention is also directed to such an interface device alone and to a use of such an interface device in said functional system arrangement of a vehicle.

According to an example embodiment of the present invention, the first and second contact surfaces are advantageously made in one piece with one another. This provides an easy-to-handle and easy-to-mount interface device with which the component-pressure rod unit can be attached to the vehicle wall in a particularly compact and stable manner. Preferably, the one-piece design is created with a deep-drawn component in which the two contact surfaces, which are at an angle to one another, have simply been shaped accordingly when manufactured.

Alternatively, according to an example embodiment of the present invention, the first and second contact surfaces are advantageously designed in two parts. This means that both contact surfaces can initially be formed independently on separately formed components that are adapted to the particular installation situation. This allows a higher degree of freedom. Preferably, a component is a known interface plate which has two mutually parallel contact surfaces on its two flat sides. A further component is preferably an adapter element which is adapted to the interface plate and has a contact surface which is at an angle to the interface plate. In this way, conventional interface plates can be used which can be advantageously combined with the adapter element or adapter made at an angle in this way. Preferably, the first contact surface is provided with the interface plate and the second contact surface is provided with the adapter. The adapter is to be arranged between the interface plate and the vehicle wall and is preferably manufactured as a die-cast or deep-drawn part. An extrusion process is particularly preferred as a manufacturing process in which the adapter is formed after extrusion of an extruded profile with correspondingly cut disks. The adapter is preferably attached to the interface plate by means of screws and nuts, a riveting process, or a welding process.

Advantageously, the interface device has a continuous free space centrally in each of its contact surfaces, which preferably serves as a mounting window. This means that the interface device can be prepared as an assembly and then mounted on the component at low cost, wherein the free space always allows direct access to a mounting level on the component.

Exemplary embodiments of the solution according to the present invention are explained in more detail below with reference to the figures.

### BRIEF DESCRIPTION OF THE DRAWINGS

FIG. 1 is a partially sectioned side view of part of a functional system arrangement according to the related art.

FIG. 2 is a plan view of another functional system arrangement according to the related art.

FIG. 3 shows the view according to FIG. 2 of a first exemplary embodiment of a functional system arrangement according to the present invention.

FIG. 4 is a partial oblique view of the embodiment according to FIG. 3.

FIG. 5 shows the detail V according to FIG. 4 in an exploded view.

FIG. 6 is a schematic plan view of a second example embodiment of a functional system arrangement according to the present invention.

FIG. 7 shows the view VII according to FIG. 6.

FIG. 8 shows the representation according to FIG. 6 in side view.

FIG. 9 is a plan view of a third example embodiment of a functional system arrangement according to the present invention.

FIG. 10 shows the detail X according to FIG. 9 in oblique view in a further variant example embodiment of the present invention.

### DETAILED DESCRIPTION OF EXAMPLE EMBODIMENTS

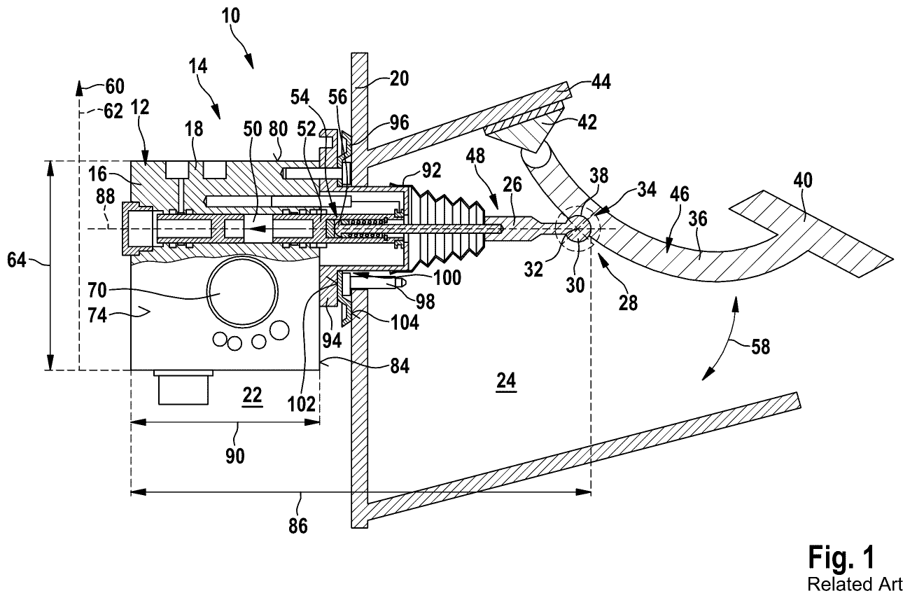

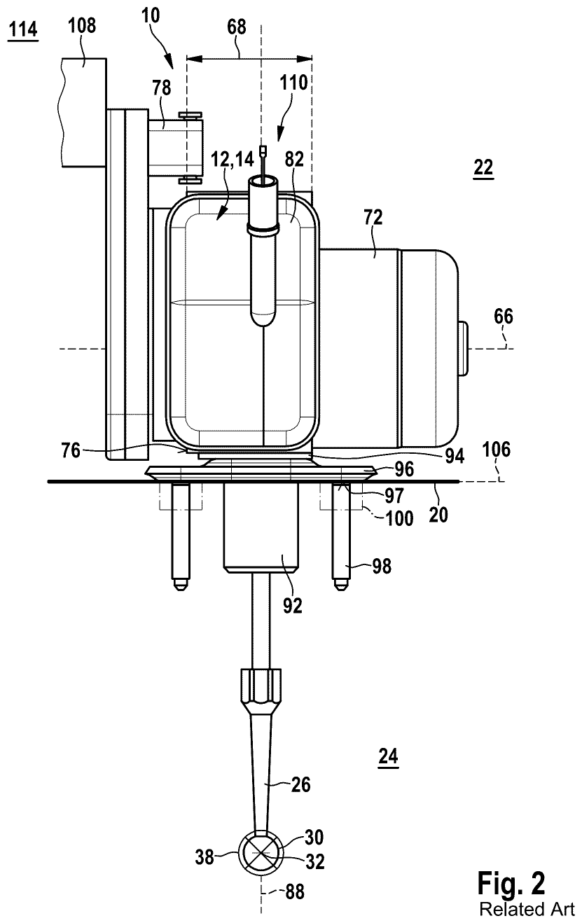

FIGS. 1 and 2 each show a functional system arrangement 10 of a hydraulic unit 12 (only partially shown) as a functional system 14 of a hydraulic vehicle brake system (not shown further) with slip control. Control systems of this kind are anti-lock brake systems, traction control systems, and/or dynamic stability control/electronic stability programs, for which the abbreviations ABS, TCS and/or DSC/ESP are commonly used.

The hydraulic unit 12 is fastened, on its hydraulic housing or housing 16, which functions as a component 18 of the functional system 14, to a vehicle wall 20 of a vehicle (not shown). The vehicle wall 20 separates an engine compartment 22 from a passenger compartment or driver compartment 24. A push rod 26 which is coupled to the housing 16 or component 18 projects into the driver's compartment 24 and is designed with a ball head 30 as a pivot point 32 at its one axial end 28 projecting into the driver's compartment 24. The pivot point 32 is held and mounted at a receiving position 34 of a curved pedal rod 36 so as to be rotatable within a certain range. The receiving position 34 is designed as a shell-shaped holding clamp or clip 38 that is open towards the pivot point 32. Furthermore, a pedal 40 is arranged on the pedal rod 36 at its lower end in the installed position, which pedal is to be actuated by a driver of the vehicle. At its upper end in the installed position, the pedal rod 36 is movably suspended from a pedal holder 42 which is fixedly arranged on a wall element 44 extending transversely to the vehicle wall 20.

The pedal 40, the pedal rod 36 with its clip 38, and the pedal holder 42 belong to a pedal device 46. The push rod 26 can be moved by means of the pedal device 46 and thus serves as a pedal travel sensor 48 with which a master brake cylinder 50 arranged in the housing 16 can be actuated, which cylinder is designed as a tandem master brake cylinder. A cup-shaped piston 52 acting as primary piston is displaceably held therein, into which the push rod 26 protrudes with its end 54 axially opposite the end 28. The end 54 is supported on the piston 52 and is mounted there with an inner pivot point 56 so as to be easily rotatable. The inner pivot point 56 is axially opposite the pivot point 32, which is located as the outer pivot point 32 in the clip 38 on the pedal rod 36 in the driver's compartment 24. When a driver actuates the pedal 40, the push rod 26 at the outer pivot point 32 is pushed in the direction of the piston 52 via a partial circular movement 58 by means of the pedal rod 26. The outer pivot point 32 is displaced slightly upwards in the Z direction 60, which is made possible within the piston 52 by the rotatable mounting of the push rod 26 at the inner pivot point 56.

In the installation position, the Z-direction 60 points substantially upwards, usually diagonally upwards. In addition, the Z-direction 60 runs along a Z-axis 62, which extends along a height or height extension 64 of the housing 16 serving as component 18. A Y-axis 66 runs perpendicular to the Z-axis 62 in a fictive right-handed Cartesian coordinate system, and extends along a width or width extension 68 of the housing 16. A receptacle 70, in which a shaft (not shown) of an electric motor or engine 72 is accommodated, extends through the housing 16 in the direction of the Y-axis 66. The engine 72 is arranged on an engine side 74 of the housing 16. On the other hand, on the cuboid-shaped housing 16 there is a control device side 76 on which an electronic control device 78 is arranged. Between the control device side 76 and the engine side 74 there is a container side 80 as a narrow side on which a container 82 for compensating storage of brake fluid is arranged (FIG. 2). A narrow side as pedal side 84 is connected to the container side 80, from which the pedal travel sensor 48 or the push rod 26 protrudes. The push rod 26 has, together with the component 18, a longitudinal extension 86 which runs along an X-axis 88 which is perpendicular to the Y-axis 66 and points in the direction of the pivot point 32. The housing 16 is arranged with its length or longitudinal extension 90 along the X-axis 88, and the master brake cylinder 50 is arranged along the X-axis 88.

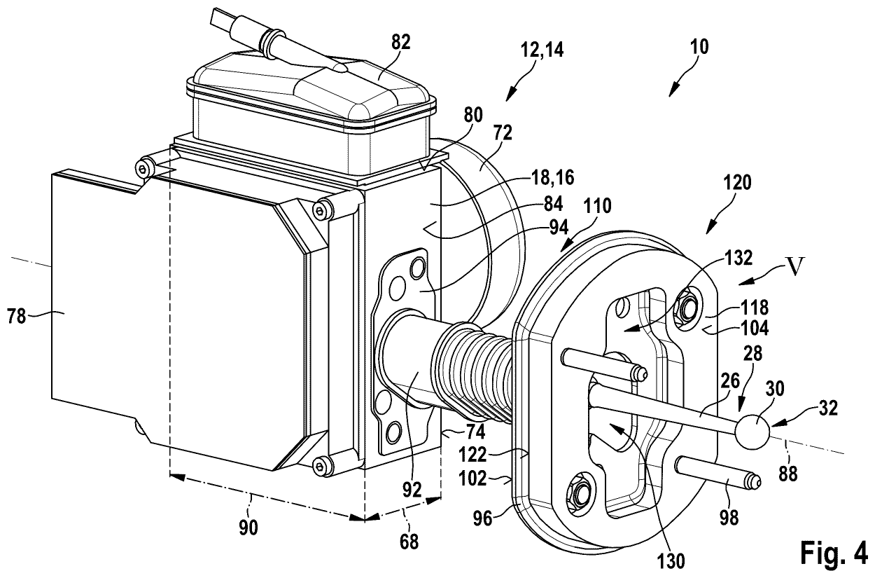

A hat-shaped adapter 92 is fastened with its adapter flange 94, which radially surrounds the push rod 26, to the pedal side 84 of the housing 16 (see also FIG. 4). An interface plate 96 is attached to the adapter flange 94, which plate presses the adapter flange 94 against the housing 16 by means of two screws (not shown). This holds the push rod 26 on the housing 16. In addition, an associated fastening element 98 protrudes from the interface plate 96 substantially perpendicularly and directed towards the vehicle wall 20 from at least one receiving point 97. Here, two fastening elements 98 with two receiving points 97 are provided, which are arranged centrally to the X-axis 88, and thus each receiving point 97 has the same distance from the X-axis 88. Each fastening element 98 extends through an associated receptacle 100 in the vehicle wall 20 and is fastened there by means of a screw nut (not shown here). This holds the housing 16 on the vehicle.

Furthermore, the interface plate 96 has a first contact surface 102 facing the housing 16 and resting there on the adapter flange 94, as well as a second contact surface 104 that is situated opposite in the X direction. The second contact surface 104 serves for placement on and fastening to the vehicle wall 20 and runs parallel to the first contact surface 102. With the contact surfaces 102, 104 arranged in parallel, the housing 16 is held parallel to the vehicle wall 20 along its pedal side 84, or width 68. The Y-axis 66 and a plane 106 formed with the vehicle wall 20 are not at an angle to each other. Furthermore, the housing 16 extends with its X-axis 88 substantially perpendicular to the plane 106 and protrudes with its length 90 in the X-direction perpendicular to the vehicle wall 20 into the engine compartment 22. There, depending on the installation space, vehicle type, and required components, there may be conflicts with at least one other component 108, such as a battery (FIG. 2). In this case, with the housing 16 as component 18 and with the push rod 26, a component-push-rod unit 110 is created, which is not rotated with its longitudinal extension 86 relative to the Z-axis 62 of the component 18 and thus represents a fictive initial position for the following embodiments.

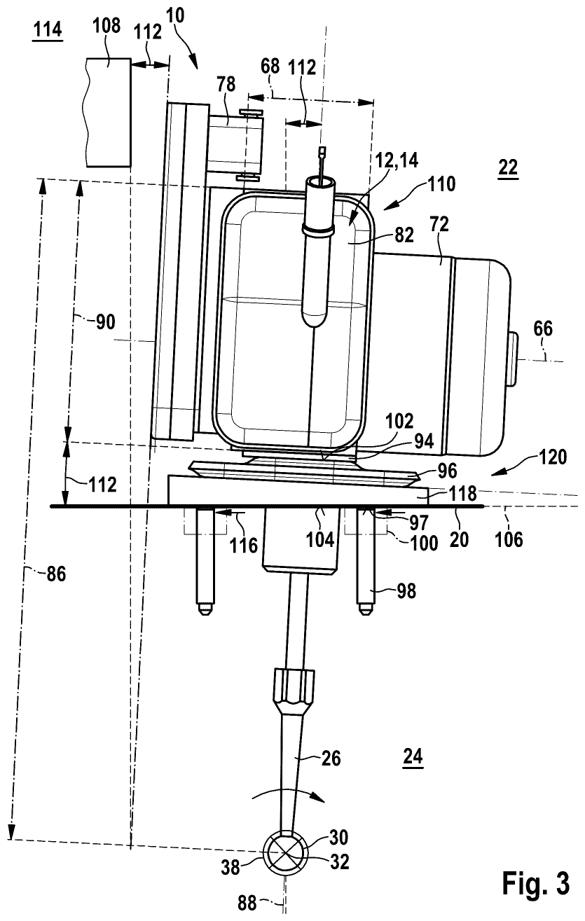

FIG. 3 shows an exemplary embodiment in which the component-push-rod unit 110 is arranged on the vehicle wall 20 at an angle 112 clockwise about the Z-axis 62 at the pivot point 32. Accordingly, the longitudinal extension 86, the X-axis 88 and the length 90 of the component 18 are rotated by the angle 112 (each dot-dashed lines) compared to the non-rotated fictive initial position (each dashed lines). Furthermore, the Y-axis 66, or the width 68 of the component 18, and the plane 106 correspondingly enclose the same angle 112. The angle 112 is approximately +3° to +4° in this case. By means of the arrangement of the component-push-rod unit 110 rotated by the angle 112, the hydraulic unit 12 as a whole and thus the control device 78 arranged thereon are positioned in the engine compartment 22 with a corresponding rotation about the Z-axis 62. This creates more space, particularly in a region 114 of the engine compartment 22 facing away from the driver's compartment 24. There, the component 108 has more space, does not touch the functional system 14 and is readily accessible for assembly or repair.

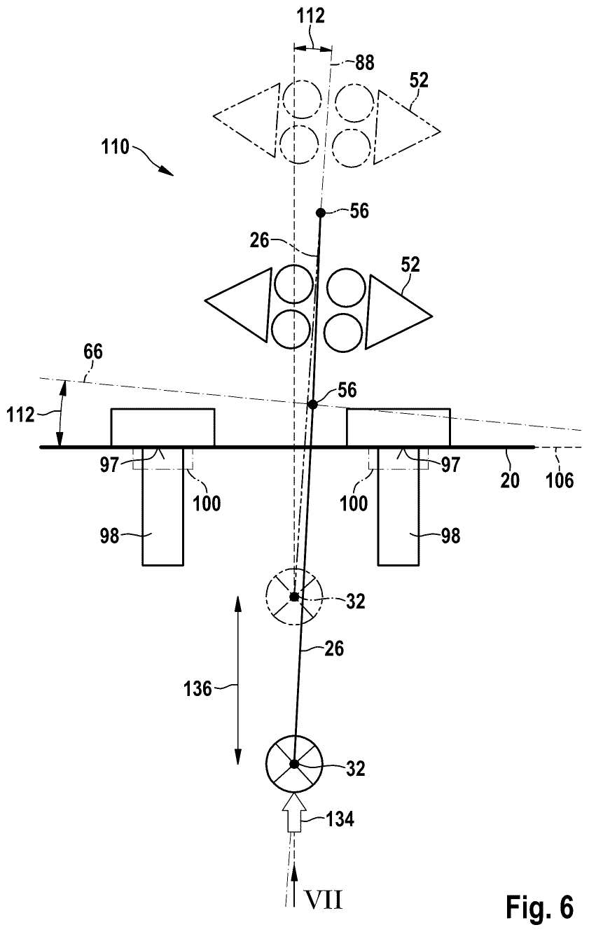

The arrangement of the component-push-rod unit 110 rotated about the Z-axis 62 is realized here by means of the ball head 30 as pivot point 32, which is located axially facing away from the component 18 at the end 28 of the push rod 28. The pivot point 32 is rotatably coupled to the receiving position 34 of the pedal device 46 in that the ball head 30 is received in the clip 38 on the pedal rod 36 in a correspondingly rotatable and positive-fitting manner. The clip 38 is designed in a manner adapted to this. At the same time, the pedal rod 36 with the pedal 40 and the pedal holder 42 is arranged unchanged from the functional system arrangement 10 shown in FIGS. 1 and 2. The pedal device 46 thus formed is not rotated (as also in FIG. 6). Thus, the driver's compartment 24, in a region facing the driver, is unchanged from known functional system arrangements 10 according to FIGS. 1 and 2.

In order to achieve the arrangement rotated about the Z-axis 62, the second contact surface 104 is also positioned at an angle to the first contact surface 102. The two contact surfaces 102 and 104 enclose the angle 112 in their fictive surface extension. The first contact surface 102 is arranged on the component 18 indirectly, in particular on the adapter flange 94 there, and is perpendicular to the X-axis 88 (dash-dotted line). The second contact surface 104 is placed on the vehicle wall 20 and encloses the angle 112 with the first contact surface 102. Furthermore, two stud bolts protrude from the second contact surface 104 as fastening elements 98, which extend through two associated receptacles 100 through the vehicle wall 20 into the driver's compartment 24 and are fastened there. Each receiving point 97 of the individual fastening element 98 on the second contact surface 104 is shifted linearly in the direction opposite the initial position, according to the angle 112 (see arrows 116). Thus, the two receiving points 97 are arranged eccentrically in relation to the X-axis 88 (dash-dotted line) according to the angle 112. The two receptacles 100 are located on the vehicle wall 20 unchanged from the initial position. Alternatively, a correspondingly linearly shifted arrangement of the receptacles 100 and an unchanged arrangement of the receiving points 97 is possible.

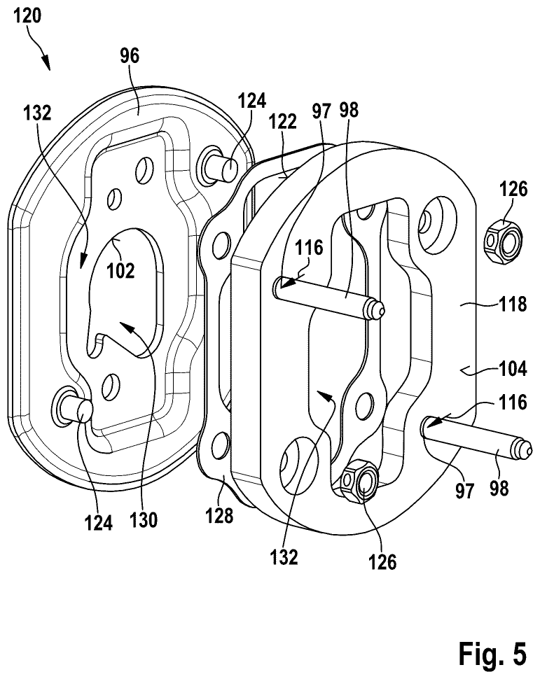

In FIGS. 4 and 5, it is shown in detail how the first and second contact surfaces 102 and 104 are positioned at an angle to each other. For this purpose, in the example shown an adapter element 118 is provided in addition to the interface plate 96. With the interface plate 96 and the adapter element 118, an interface device 120 is created in which the first contact surface 102 and the second contact surface 104 are made in two parts relative to one another. The first contact surface 102 here belongs to the interface plate 96 and is arranged on the adapter flange 94 and thus indirectly on the housing 16. The adapter element 118, which is formed at an angle, is arranged on the interface plate 96 opposite the first contact surface 102. For this purpose, the adapter element 118 has a third contact surface 122 which is placed on the interface plate 96 and forms the second contact surface 104 with its side facing away from the housing 16. The second and third contact surfaces 104 and 122 are positioned at an angle to each other such that the angle 112 is included in their fictive surface extension. Thus, the second contact surface 104 of the adapter element 118 and the first contact surface 102 of the interface plate 96 are positioned at an angle to one another according to the angle 112. Thus, the interface plate 96 is designed as a first component with two planes parallel to each other, while the necessary angle 112 or angle of rotation is realized with the adapter element 118. The interface plate 96 is preferably made of steel, in particular as a deep-drawn part, and is fastened to the adapter element 118 by means of two screws 124 and associated nuts 126. Axially in between, a seal 128 designed as a flat dry seal is provided.

Furthermore, the interface device 120 has a continuous opening 130 in each of its contact surfaces 102, 104 and 122 as well as in the seal 128, through which opening the adapter 92 is guided. The opening 130 widens away from the housing 16 to form a mounting window 132 with a larger cross section and clearance. The mounting window 132 allows direct access to a mounting level on the pedal side 84.

FIGS. 6 to 8 schematically show an exemplary embodiment of the functional system arrangement 10 arranged rotated about the Z-axis, in the actuated and non-actuated state. The double-dash-dotted lines refer to components that change in the actuated state compared to the rest position, such as the pedal 40, the pedal rod 36, the push rod 26, the outer pivot point 32, the inner pivot point 56, and the piston 52. The same components with the same reference signs 40, 36, 26, 32, 56, and 52 are shown in the rest position with solid lines.

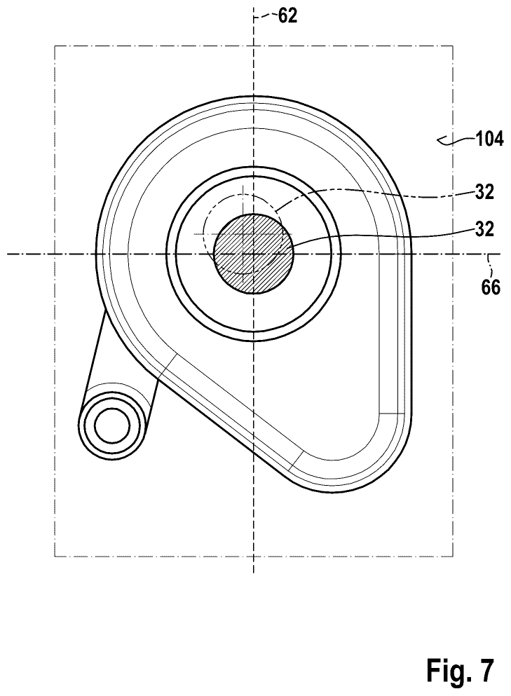

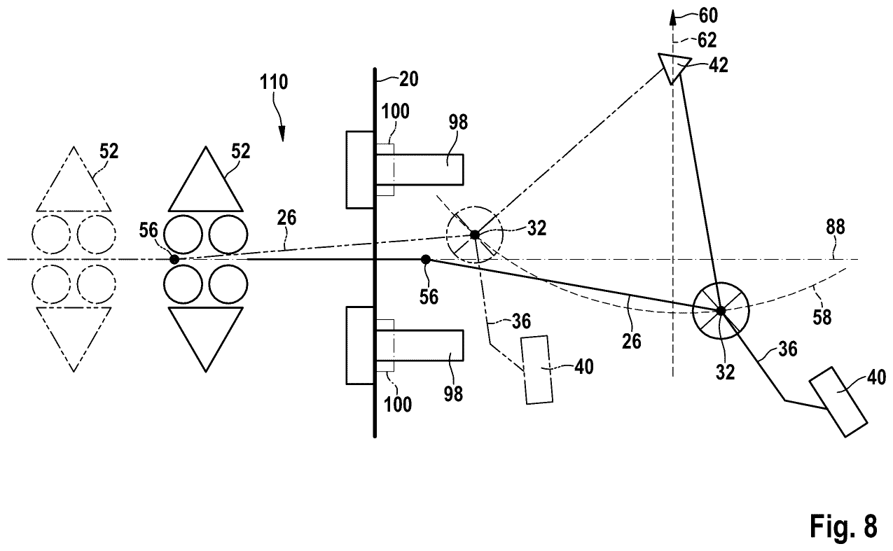

The pedal device 46 with the pedal rod 36 and the pedal 40 is not rotated relative to the Z-axis 62 here, and runs perpendicular to the vehicle wall 20, as shown in FIG. 6 with the arrow 134 and the dashed line. The push rod 26 is rotated by means of the outer pivot point 32 such that the dash-dotted X-axis 88 results. When the pedal 40 is actuated, the push rod 26 rotated in this manner is pushed at the outer pivot point 32 via the partial circular movement 58 of the pedal 40 by means of the pedal rod 26 in the direction of the piston 52. The outer pivot point 32 is displaced by a distance 136 in the X direction (FIG. 6) and slightly upwards in the Z direction 60 (FIG. 8). In addition, the rotated arrangement results in a slight offset of the outer pivot point 32 along the Y-axis 66 under load, as shown in FIGS. 6 and 7. This offset has proven to not be disturbing in terms of possible bending forces.

Furthermore, in the embodiment according to FIGS. 6 to 8 both the receiving points 97 of the individual fastening element 98 and the receptacles 100 are adapted to the arrangement rotated by the angle 112.

In a further preferred embodiment, not shown here, the pedal device 46 with its pedal rod 36 and its pedal 40 is arranged rotated at the same angle 112 with respect to the Z-axis 62 as the component-push-rod unit 110. This avoids the described offset of the outer pivot point 32 along the Y-axis 66 and yet provides more space in the region 114 of the engine compartment 22.

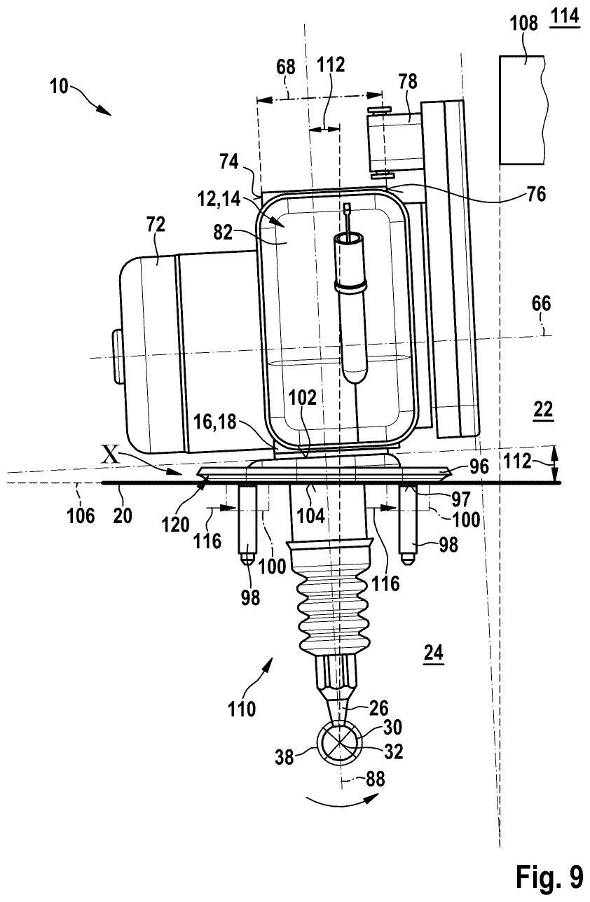

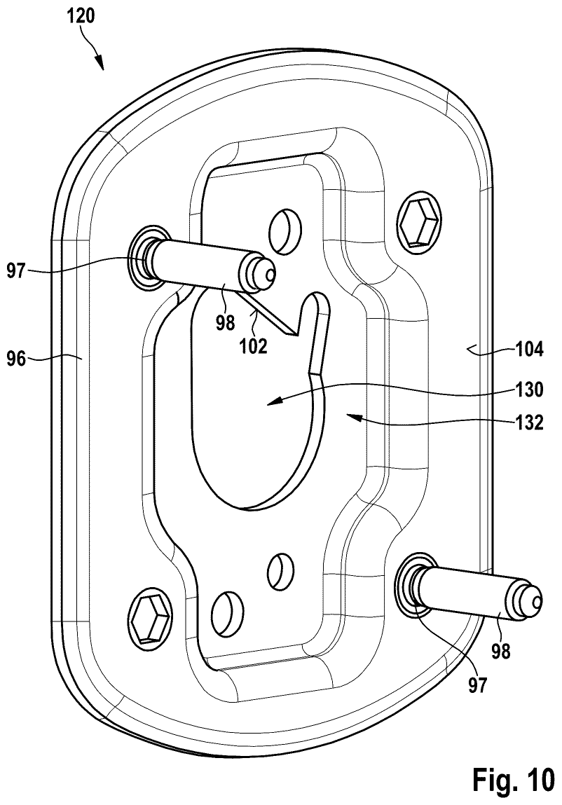

FIGS. 9 to 10 show an embodiment of the functional system arrangement 10, in which the component-push-rod unit 110 is arranged rotated counterclockwise by the angle 112 at the pivot point 32 about the Z-axis 62 on the vehicle wall 20. The angle 112 here is approximately −2° to −3°. Accordingly, the Y-axis 66, or the width 68 of the component 18, and the plane 106 in their imaginary extensions enclose the same angle 112 (each shown by a dash-dotted line in relation to the corresponding dashed line in each case). In addition, the X-axis 88 is also rotated counterclockwise about the Z-axis 62. In particular, this creates more space in the direction of travel to the right of the functional system 14 in the region 114 of the engine compartment 22 facing away from the driver's compartment 24.

The two receptacles 100 in the vehicle wall 20 are unchanged from the fictive initial position, while in each case the associated receiving point 97 of the individual fastening element 98 on the second contact surface 104 is arranged shifted linearly in the opposite direction relative to the fictive initial position, corresponding to the angle 112 (see arrows 116).

In addition, the interface device 120 is made with an interface plate 96 whose planes do not run parallel to each other, but are at an angle to each other. The interface plate 96 thus has both the first contact surface 102 facing the component 18 and the second contact surface 104 which is to be placed on the vehicle wall 20 and which is positioned at an angle to the first contact surface 102. Thus, the two contact surfaces 102 and 104 are made in one piece relative to each other. For this purpose, the interface device 120 is formed with a deep-drawn component which, as a stepped plate, also has the opening 130 in the center, which widens in the direction of the second contact surface 104 as a mounting window 132.

According to FIG. 10, a variant embodiment of the interface device 120 with two contact surfaces 102 and 104 at an angle to one another is shown, in which the two receiving points 97 are not linearly displaced, but are arranged centrally to the X-axis 88. A suitable fastening is then realized on the vehicle wall 20.

Furthermore, in a further embodiment not shown here, the component-push-rod unit 110 is rotated at the pivot point 32 by an angle about the Y-axis 66 in addition to the angle 112. This allows even more variations for space in the engine compartment 22. For this purpose, the interface device 120 is preferably designed such that its two contact surfaces 102, 104 are arranged correspondingly at an angle to one another and rotated relative to one another.

In addition, the functional system arrangement 10 with the arrangement of the component-push-rod unit 110 rotated about the Z-axis is suitable for various functional systems 14, each of which has a push rod 26 and is to be arranged on the vehicle wall 20. The exemplary embodiments shown have different types of hydraulic units 12 as functional system 14. FIGS. 3 to 8 show a so-called regular type of hydraulic power unit 12, in which the pressure rod 26 is arranged with its master brake cylinder 50 between the receptacle 70 associated with the engine 72 and the container side 80. The control device 78 is arranged on the left side of the component 18 in the direction of travel, and the arrangement rotated in the clockwise direction correspondingly creates more space on the left side in the region 114. Furthermore, FIGS. 9 to 10 show a so-called inverse type hydraulic unit 12, in which the master brake cylinder 50 is arranged on the side facing away from the container side 80 in relation to the receptacle 70. The control device 78 is usually arranged on the right side of the component 18 in the direction of travel. With the arrangement rotated anti-clockwise, more space is then provided on the right side in the region 114.

In a further variant embodiment not shown, the functional system 14 is a brake booster with a cup-shaped booster housing as component 18, into which the push rod 26 protrudes axially.

What is claimed is:

1. A functional system arrangement for a vehicle brake system in an associated vehicle on a vehicle wall of the vehicle, the functional system arrangement comprises:
a component of a functional system of the vehicle brake system to be fastened to the vehicle wall; and
push rod coupled to the component;
wherein the component has a length extending along an X-axis and a height extending along a Z-axis perpendicular to the X-axis, and a component-push-rod unit is formed with the component and the push rod, the component-push-rod unit running with its longitudinal extension along the X-axis;
and wherein the component-push-rod unit is to be arranged on the vehicle wall rotated by an angle about the Z-axis.

2. The functional system arrangement according to claim 1, wherein at least one fastening element to be coupled to the component is provided, a receiving point of the fastening element is arranged eccentrically in relation to the X-axis in accordance with the angle.

3. The functional system arrangement according to claim 1, wherein at least one receptacle arranged on the vehicle wall is provided and is arranged eccentrically in relation to the X-axis in accordance with the angle.

4. The functional system arrangement according to claim 1, wherein an arrangement of the component-push-rod unit rotated about the Z-axis is created using a pivot point which is positioned on the push rod, axially facing away from the component.

5. The functional system arrangement according to claim 4, wherein the pivot point is rotatably coupled to a receiving position of an associated pedal device.

6. The functional system arrangement according to claim 5, wherein the pedal device is not arranged rotated.

7. The functional system arrangement according to claim 1, wherein the component-push-rod unit is additionally to be arranged on the vehicle wall rotated at an angle about the Y-axis.

8. The functional system arrangement according to claim 1, further comprising:
an interface device configured to fasten the push rod to the component and to fasten the component to the vehicle wall, wherein the interface device has a first contact surface coupled to the component and a second contact surface to be applied to the vehicle wall, and the second contact surface is positioned at an angle to the first contact surface such that the arrangement of the component-push-rod unit rotated by the angle about the Z-axis is achieved.

9. The functional system arrangement according to claim 8, wherein the first contact surface and the second contact surface are formed in one piece with one another.

10. The functional system arrangement according to claim 8, wherein the first contact surface and the second contact surface are formed in two parts relative to one another.
